(19) United States
(12) Patent Application Publication
(10) Pub. No.: US 2013/0218783 A1
(43) Pub. Date: Aug. 22, 2013

(54) APPARATUS AND METHOD FOR REAL-TIME DATA CAPTURE AND USAGE FOR FAULT REPAIR

(71) Applicant: Digital Manufacturing, Inc., (US)

(72) Inventor: Arnav ANAND, Berkeley, CA (US)

(73) Assignee: DIGITAL MANUFACTURING, INC., Berkeley, CA (US)

(21) Appl. No.: 13/773,456

(22) Filed: Feb. 21, 2013

Related U.S. Application Data
(60) Provisional application No. 61/601,038, filed on Feb. 21, 2012.

(51) Int. Cl. G06Q 10/00

(52) U.S. Cl. CPC G06Q 10/20
USPC 705/304

(57) ABSTRACT

A method for troubleshooting and providing technical support using a real-time transmission of audio data and video data. The method can include receiving a signal associated with a problem of a piece of equipment, instrument or machinery; in response to receiving the signal, initiating a communication channel capable of transmitting troubleshooting information between a user at a local site of the piece of equipment, instrument, or machinery, and at least one service representative at a remote site; transmitting information between the service representative and the user relating to the equipment, instrument, or machinery for purposes of troubleshooting the problem; and uploading a video of troubleshooting for the user relating to the equipment, instrument, or machinery taken at the local site. Accordingly, the method can be used to transmit and capture real-time fault diagnosis, troubleshooting analysis, and repair of equipment, instruments, and appliances.

This application claims the benefit of the filing date of U.S. Provisional Application No. 61/601,038, filed on Feb. 21, 2012, which is hereby incorporated by reference.

### FIELD OF THE INVENTION

This invention relates generally to the field of data capture and data use for fault diagnosis, remote troubleshooting, field services, and repair.

### BACKGROUND

In manufacturing or other business or industrial settings, when equipment, instruments, or appliances have problems or stop functioning, the on-site user is typically responsible for fixing the problem. If the problem cannot be resolved by the user, a field engineer or service representative from the company that manufactures the equipment, instrument, or appliance may be sent to his location for assistance. Logistics and the complications arising from the troubleshooting process can sometimes result in equipment downtime of a few hours to days and sometimes even weeks.

The extended downtime leads to several problems. First, it can result in lost opportunities that may amount to significant sums of money. For example, the lost opportunity cost can be hundreds of thousands of dollars due to idle labor, increased lead time, backlogs, disrupted supply chain, and the possibility of losing customers, either temporarily or permanently.

Second, the downtime can result in significant costs to the owner of the equipment, instrument or appliance. Sending a field engineer or service representative out to the worksite can result in lost productivity time due to travel time. In addition to the high support costs, pressure from customers to deliver products on time can lead to decreased margins and strained customer relationships.

In attempting to build a troubleshooting system for the future, there are several challenges to overcome. First, lessons learned from troubleshooting experiences are not stored or applied for future incidents requiring troubleshooting. Instead, the troubleshooting procedures typically start the process from scratch with each incident. Second, operating instructions for equipment, instruments, and appliances are generally mostly textual in nature and thus not easily applied to troubleshooting procedures when the need arises. Third, businesses rarely include troubleshooting or technical support information as part of their customer research. Instead, customer research is typically limited to market research and in-person interviews. The mechanism to capture the customer feedback generally involves the taking of detailed textual notes, which may be biased due to the understanding and perceptions of the interviewer. When feedback is relayed from customer service representatives, to sales and marketing personnel and ultimately to product development engineers, the feedback is often misconstrued and lacks prescriptive details.

For these reasons, there is a need for a system and method that can help in the diagnosis and repair of equipment, instruments, appliances. Embodiments of the present invention attempt to resolve these issues.

### SUMMARY OF INVENTION

In accordance with the disclosed subject matter, structures and methods for fault diagnosis and repair are disclosed.

According to one embodiment, a method of the invention includes uploading a plurality of videos of troubleshooting collaborations between at least one service representative and at least one local site having equipment to be repaired, wherein the videos are taken at the at least one local site; developing a searchable database of the videos of troubleshooting collaborations, wherein developing the searchable database includes tagging the videos for data analytics; and responding to a search request for troubleshooting an operation of a particular piece of equipment, wherein the response includes video data from the searchable database.

Another embodiment of the invention is a computer-readable storage media embodying logic that is operable when executed to perform a series of steps. These steps include uploading a plurality of videos of troubleshooting collaborations between at least one service representative and at least one local site having equipment to be repaired, wherein the videos are taken at the at least one local site; developing a searchable database of the videos of troubleshooting collaborations, wherein developing the searchable database includes tagging the videos for data analytics; and responding to a search request for troubleshooting an operation of a particular piece of equipment, wherein the response includes video data from the searchable database.

According to another embodiment, a method of the invention includes receiving a signal associated with a problem of a piece of equipment, instrument or machinery; in response to receiving the signal, initiating a communication channel capable of transmitting troubleshooting information between a user at a local site of the piece of equipment, instrument, or machinery, and at least one service representative at a remote site; transmitting information between the service representative and the user relating to the equipment, instrument, or machinery for purposes of troubleshooting the problem; and uploading a video of troubleshooting for the user relating to the equipment, instrument, or machinery taken at the local site. The troubleshooting information can be transmitted in real-time to result in a real-time collaboration.

Another embodiment of the invention is a computer-readable storage media embodying logic that is operable when executed to perform a series of steps. These steps include receiving a signal associated with a problem of a piece of equipment, instrument or machinery; in response to receiving the signal, initiating a communication channel capable of transmitting troubleshooting information between a user at a local site of the piece of equipment, instrument, or machinery, and at least one service representative at a remote site; transmitting information between the service representative and the user relating to the equipment, instrument, or machinery for purposes of troubleshooting the problem; and uploading a video of troubleshooting for the user relating to the equipment, instrument, or machinery taken at the local site.

### BRIEF DESCRIPTION OF THE DRAWINGS

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other embodiments as well.

FIG. 1 is a block diagram that shows the environment of one embodiment of the invention;

FIG. 2 is a block diagram that shows greater detail of the server system 102 shown in FIG. 1;

FIG. 3 is a block diagram that shows greater detail of the expert workstation 103 shown in FIG. 1;

FIG. 4 is a block diagram that shows greater detail of the client system 104 shown in FIG. 1; and

FIG. 5 is a flow diagram of a method in accordance with certain embodiments of the disclosed subject matter.

### DETAILED DESCRIPTION

The present invention relates to real-time collaboration, data capture and usage of the data for fault-diagnosis and repair, where one potential use is in the area of troubleshooting problems, faults, and failures in equipment, instruments, and appliances.

The embodiments of the invention set forth herein can be implemented using software/program code to perform the described functions. The embodiments may, for example, use a machine readable medium configured to cause the machine/processor to execute the methods in the manners described herein.

Video communication can be a far more engaging and interactive medium than many other feedback mechanisms. Video presentations, for instance, can be an easy mode of instruction that makes it simple for the people to understand and learn for future reference. For example, the impact of Khan Academy videos with respect to educating children demonstrates the power of such a medium for learning and instruction. Similarly, some embodiments of the invention use videos to educate product builders and technicians.

Accordingly, in the invention, real-time video communication can be utilized for the purpose of enabling personal meetings, professional meetings, document sharing/presenting, and in some cases for allowing for sharing each other's computers. Video chat over mobile devices such as smart phones, tablets, and other devices with a physical camera may also be used for collaboration over diagnostics and inspection of physical equipment, instruments, and appliances. The system and method described herein not only enables the capture and preservation of video feedback, but also the types of problems suffered by the equipment, instrument, or appliance.

In addition, the system and method can be used to extract relevant analytics and provide intelligence for increasing the productivity as well as improving the next generation of the products.

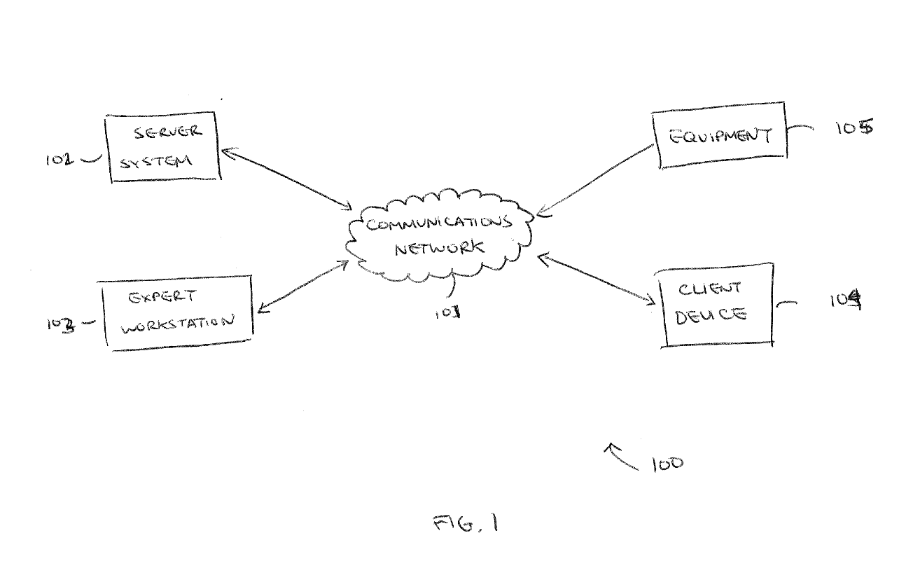

FIG. 1 illustrates a diagram of a networked electronic system in accordance with an embodiment of the invention. The networked system 100 can include a communications network 101, server system 102, an expert workstation 103, a client device 104, and a connected equipment module 105.

The communications network 101 connects the server system 102, the expert workstation 103, a client device 104 and a connected equipment module 105. The communication network 101 can include the Internet, a cellular network, a telephone network, a computer network, a packet switching network, a line switching network, a local area network (LAN), a wide area network (WAN), a global area network, or any number of private networks that can be referred to as an Intranet. Such networks may be implemented with any number of hardware and software components, transmission media and network protocols. FIG. 1 shows the communications network as individual links; however, the network can include the multiple interconnected networks listed above.

The server system 102 manages the networked system 100, monitoring the connectivity to all of the other components through the communications network 101, such as the expert workstation 103, a client device 104 and a connected equipment module 105. The server system 102 may be a computer system, comprising computer servers and a computer network for managing incoming signals from the equipment module 105 and transmitting video data and audio data to and from the expert workstation 103 and the client device 104.

The expert workstation 103 may be at a remote site from the equipment 105 to be repaired. The expert workstation 103, in general, can be used by one or more service representatives to establish a connection to the local site (which can include, for instance, the equipment 105 and client device 104) for a troubleshooting session. The use of the expert workstation 103 is described in greater detail below. The expert workstation 103 may be any number of electronic devices capable of receiving and processing the client digital content data stream, such as a personal computer, a mobile computer, a mobile electronic device, a personal electronic device, an electronic or computer system, computer server, or a network of computer servers and systems, that send signals through communications network 101 to the server system 102 and the client device 104. In some embodiments, the expert workstation 103 may be capable of transmitting audio data and video data. The expert workstation 103 and server 102 can be located at a common remote site, at different sites, and can be coupled together. In addition, it is possible within the scope of the invention to use the server 102 to perform the functions of both the server and the expert workstation 103 as described herein.

The client device 104 can be located on site with the equipment 105, or somewhere close to the equipment 105, and can be used by local technicians, engineers, or personnel in connection with troubleshooting the equipment 105. As with the expert workstation 103, the client device 104 may be any number of electronic devices capable of receiving and processing the client digital content data stream, such as a personal computer, a mobile computer, a mobile electronic device, a personal electronic device, an electronic or computer system, computer server, or a network of computer servers and systems, that send signals through communications network 101 to the server system 102. In some embodiments, client device 104 may be coupled to the equipment module 105 or can even be part of the equipment module 105. In some embodiments, client device 104 may be capable of transmitting audio data and video data. According to the some embodiments, the server system 102 may receive video data comprising a plurality of videos of troubleshooting collaborations between at least one service representative working on the expert workstation 103 and at least one local site having equipment 105 to be repaired, wherein the videos are taken using the client device 104. The server system 102 may also be able to send video data to the client device 104 for helping in troubleshooting.

The equipment module 105 may be an electronic device capable of transmitting a signal through communications network 101 to the server system 102 to indicate equipment failure. Based on the signal from the equipment module 105, the server system will diagnose the problem and issue a ticket for the failure.

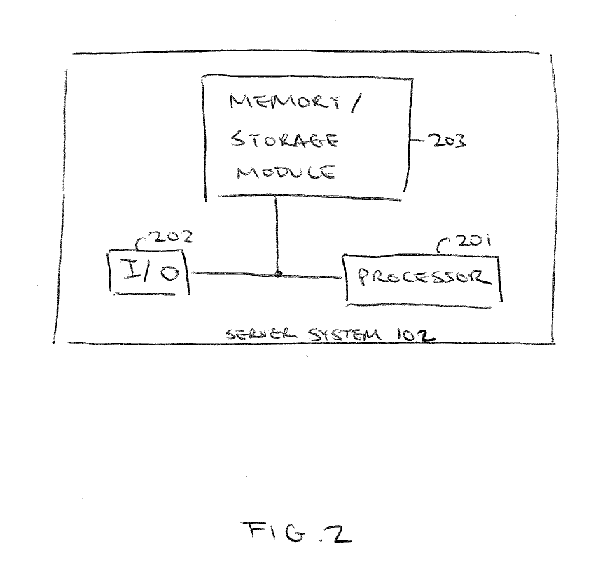

FIG. 2 is a block diagram that shows greater detail of the server system 102 from FIG. 1. At a high level, the server system 102 comprises a processor 201, an input/output component 202, and a memory/storage module 203.

Processor 201 can be configured as a central processing unit or application processing unit in the server system 102 from FIG. 1. Processor 201 might also be implemented in hardware using an application specific integrated circuit (ASIC), programmable logic array (PLA), field programmable gate array (FPGA), or any other integrated circuit or circuit structure that can perform the functionality of server system 102 from FIG. 1.

Input/output component 202 may comprise a specialized combination of circuitry (such as ports, interfaces, wireless antennas) and software (such as drivers) capable of handling the receiving signals and video data from source computers 103-1 through 103-N, sending signals and video data from client computers 104-1 through 104-N.

Memory/storage module 203 comprise cache memory, flash memory, a magnetic disk drive, an optical drive, a programmable read-only memory (PROM), a read-only memory (ROM), or any other memory or combination of memories. The memory/storage module 203, therefore, can be a non-transitory computer readable medium of a variety of types known to those skilled in the art.

In accordance with some embodiments, the memory/storage module 203 may also be sufficient to store the video data in a database in some embodiments. In some embodiments of the invention, the memory/storage module 203 may store the data from troubleshooting incidences that leads to increased productivity and utilization by reducing external dependencies during future break-downs and hence the downtime iteratively.

In accordance with some embodiments of the invention, the processor 201 may be capable of executing a software program that allows manual as well as automatic editing of the audio data and video data in the memory/storage module 203 in order to enrich the data in memory/storage module 203 to be highly searchable and usable in the future. Some embodiments may improve searchability using metatags and associative keywords.

In accordance with certain embodiments, the processor 201 of server system 102 may be capable of searching the memory/storage module 203 for videos of troubleshooting collaborations and tagging the videos for data analytics.

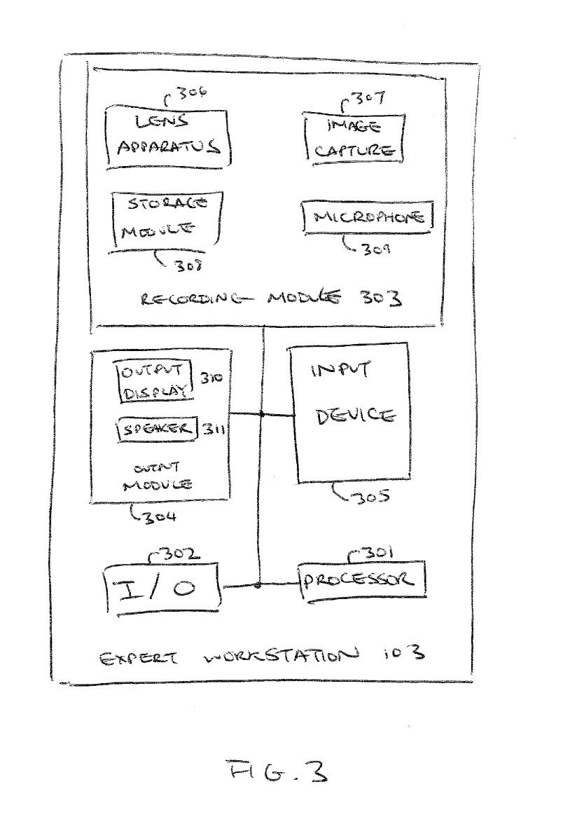

FIG. 3 is a block diagram that shows greater detail of the expert workstation 103 from FIG. 1. At a high level, the expert workstation system 103 comprises a processor 301, an input/output component 302, a recording module 303, an output module 304, and an input device 305.

Similar to processor 201, processor 301 can be configured as a central processing unit or application processing unit in the expert workstation 103 from FIG. 1. Processor 301 might also be implemented in hardware using an application specific integrated circuit (ASIC), programmable logic array (PLA), field programmable gate array (FPGA), or any other integrated circuit or circuit structure that can perform the functionality of client system 104 from FIG. 1. In accordance with some embodiments, the processor 301 may be capable of managing the sending and receiving of audio and video data through the input/output component 302 to the output module 304.

Input/output component 302 may comprise a specialized combination of circuitry (such as ports, interfaces, wireless antennas) and software (such as drivers) capable of receiving and sending signals, audio data, and video data from the server system 102 through the communications network 101.

Recording module 303 may be a camera apparatus that includes a lens apparatus 306, an image capture module 307 and storage module 308. The recording module 303 may be functional to focus on objects, such as the equipment user at the local site, capture the image or video using the capture module 307, and store the image or video in storage module 308 prior to transmission using the input/output component 302 to the server system 102 or the client device 104 through communications network 101. In some embodiments, the recording module 303 may include a microphone 309 that can record audio data for transmission.

Output module 304 may comprise an output display 310 and a speaker 311. Output display 310 may be functional to display video data that is retrieved from the database in memory/storage module 303 in server system 102 through communications network 101.

The input device 305 can be configured as a combination of circuitry and/or software capable of receiving an input signal. In some embodiments, the input device 305 can be configured as a touchscreen and controller chip in combination with specific driver software. In such embodiments, the input device 305 can be configured to sense inputs on a touchscreen from a stylus or one or more fingertips. In other embodiments, the input device 305 can be configured to sense inputs from a mouse, trackball, touchpad, track pad, control stick, keyboard, or other input device.

In some embodiments of the invention, the processor 301 in expert workstation 103 may execute an easy-to-use and interactive video chat software platform over camera-equipped (e.g. recording module 303) devices to collaborate and troubleshoot the problems with equipment, instruments, appliances in real-time immediately with the appropriate engineer or field service representative instead of waiting for them to come to the local site in person.

In another embodiment of the invention, the expert workstations 103 may be used to create step-by-step instructional video and audio recordings to help troubleshoot future problems. These recordings may then be stored at the server system 102 and may be available for playback at client device 104 in case of equipment, instrument or appliance failure as indicated by a signal from the equipment module 105. These recordings may also be used as part of a training curriculum for employees to enhance their skillset.

In some embodiments, the expert workstation 103 may be operated by a marketing or sales personnel, engineering personnel, or customer support representatives. This would allow real-time, virtual collaboration between the user with the equipment failure and the entire vendor support team.

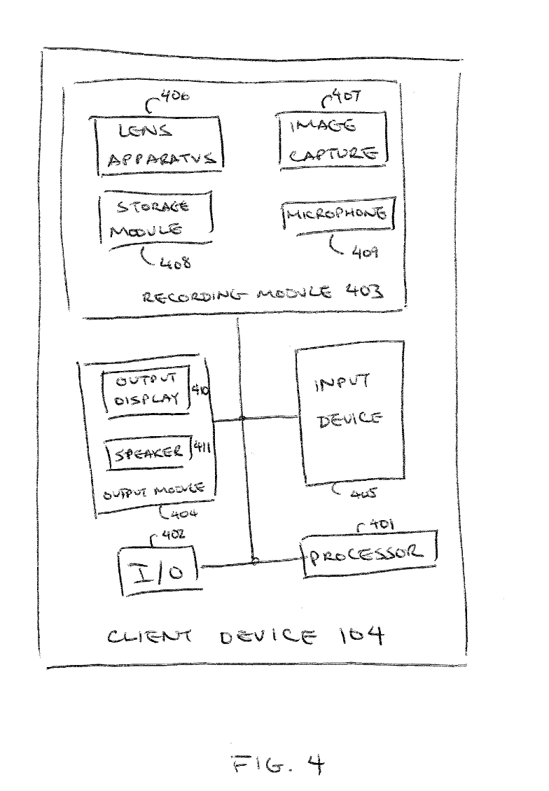

FIG. 4 is a block diagram that shows greater detail of the client system 104 from FIG. 1. At a high level, the client system 104 comprises a processor 401, an input/output component 402, a recording module 403, an output module 404, and an input device 405.

Processor 401 can be configured as a central processing unit or application processing unit in the server system 102 from FIG. 1. Processor 401 might also be implemented in hardware using an application specific integrated circuit (ASIC), programmable logic array (PLA), field programmable gate array (FPGA), or any other integrated circuit or circuit structure that can perform the functionality of client system 104 from FIG. 1. In accordance with some embodiments, the processor 401 may be capable of managing the sending and receiving of audio and video data through the input/output component 402 to the output display 404.

Input/output component 402 may comprise a specialized combination of circuitry (such as ports, interfaces, wireless antennas) and software (such as drivers) capable of receiving and sending signals, audio data, and video data from the server system 102 through the communications network 101.

Recording module 403 may be a camera apparatus that includes a lens apparatus 406, an image capture module 407 and storage module 408. The recording module 203 may be functional to focus on objects, such as the equipment user at the local site, capture the image or video using the capture module 407, and store the image or video in storage module 408 prior to transmission using the input/output component 402 to the server system 102 through communications network 101. In some embodiments, the recording module 403 may include a microphone 409 that can record audio data for transmission.

As with output module 304 in the expert workstation 103, the output module 404 in the client device 104 may comprise an output display 410 and a speaker 411. Output display 410 may be functional to display video data that is retrieved from the database in memory/storage module 203 in server system 102 through communications network 101. In some embodiments it may be functional to display video data and audio data captured in the recording module 303 in the expert workstation 103.

The input device 405 can be configured as a combination of circuitry and/or software capable of receiving an input signal. In some embodiments, the input device 405 can be configured as a touchscreen and controller chip in combination with specific driver software. In such embodiments, the input device 405 can be configured to sense inputs on a touchscreen from a stylus or one or more fingertips. In other embodiments, the input device 405 can be configured to sense inputs from a mouse, trackball, touchpad, track pad, control stick, keyboard, or other input device.

In some embodiments of the invention, the processor 401 in client device 104 may execute an easy-to-use and interactive video chat software platform over camera-equipped (e.g. recording module 403) mobile devices to collaborate and troubleshoot the equipment, instruments, appliances problems in real-time immediately with the appropriate engineer or field service representative instead of waiting for them to come. This would allow for the fundamental human senses of vision, voice, and pseudo touch to make effective troubleshooting.

In some embodiments of the invention, the client device 104 may access a web- and cloud-based interface that captures the audio data and video data being transferred in real-time between the expert workstation 103 and the client device 104 through the communications network 101. In these embodiments, the input/output component 302 in the expert workstation 103 and the input/output component 402 in the client system 104 must be able to handle the simultaneous transfer of audio data and video data back and forth through communications network 101.

In some embodiments, this real-time broadcast may stream diagnostic and repair information to the client device 104 at the local site from the expert workstation 103 at a remote site. In some embodiments, the repair and diagnostic information may include instructional video data that is superimposed or presented in an overlay above the video data from the client device 104. This data may be in an animated Computer Aided Drawing (CAD) format or hand-drawn through collaboration between the client device 104 and expert workstation 103. The superimposing of the CAD model, or the whiteboard mark-ups, augments the real-time video feed to simulate a hypothetical configuration and helps the local user at client device 104 precisely understand the troubleshooting instructions communicated by the service representative at the expert workstation 103. In this manner, the customer service representative using the expert workstation 103 at a remote site may present relevant instructional information to the user at the local site of the equipment, instrument, or appliance to resolve a failure in real-time.

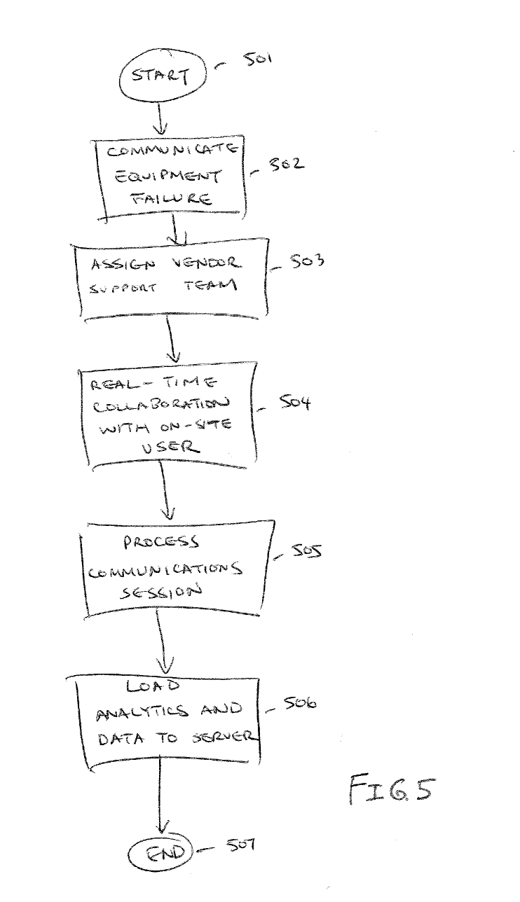

FIG. 5 is a flow chart that illustrates the operation of one embodiment of the invention. In FIG. 5, start block 501 can be initiated by a failure or problem arising in an equipment, instruction or appliance. Assuming the on-site user cannot resolve the problem on his or her own, the networked equipment module 105 may transmit a signal to the server system 102 through the communications network 101 as shown in Step 502. In Step 503, the server system 102 may issue a support ticket to the appropriate vendor support team and send the appropriate signal and/or communication to the expert workstation 103.

In accordance with some embodiments, the processor 201 of server system 102 may be capable of executing an algorithm that is stored in the memory/storage module 203 that detects and suggests the most appropriate vendor support team depending on the type of failure, the expertise of the vendor support team members, and the relative locations of the vendor support team members and the problematic equipment, instrument, or appliance. The results of these analytics may also be stored in the memory/storage module 203.

In Step 504, the vendor support team, including service representatives who may be marketing and sales personnel or engineers, may use the expert workstation 103 to establish a communications connection with the client device 104, which is presumably manned by the on-site user with the equipment failure. In some embodiments, the vendor support team may communicate with the on-site user in real-time using video and audio technologies through the communications network 101 to resolve the problem. In some embodiments, the client device 104 or equipment 105 and the server system 102 will monitor, capture, and record the entire video and audio communication session between the expert workstation 103 and the client device 104 for subsequent analysis and archival use.

In Step 505, the server system 102 will process the recorded video and audio communications session. In some embodiments, this may include using professional video editing techniques and metadata tagging. In some embodiments, this editing may be done using an automated algorithm that is stored in the memory/storage module 203 and executed using the processor 201. In some embodiments, this editing may be done using professionally trained engineers.

In some embodiments, the processing of the recorded video and audio communications may also include performing data analytics. These data analytics may include root cause analysis, prognostics monitoring, predictive failure, and preventive maintenance analytics to provide better intelligence and information about optimizing their processes. Root cause analysis may involve analyzing the causes for failure in equipment, instruments, and appliances based on the conditions, frequency of failure, and usage patterns. Prognostics monitoring and predictive failure may involve analyzing potential risks based on the logistics of currently deployed equipment, instruments, and appliances. Preventative maintenance analytics involves prescribing recommended solutions that may reduce the likelihood of failure in currently deployed equipment, instruments, and appliances.

In Step 506, the data analytics and processed video and audio data may be loaded onto the server system 102 for access via the communications network 101. In doing so, insights into equipment, instrument, and appliance failures may be shared with all users. Once complete, the process flow is complete in Step 507.

In accordance with some embodiments of the invention, the server system 102 may host a web-based “How to instruction” platform, or “KnowledgeBase,” that stores troubleshooting instructional videos from memory/storage module 203 and maintain feedback forums, the contents of which may also reside on memory/storage module 203. The platform will engender a virtual community of users of the same types of equipment, instruments, or appliances to discuss, educated, and generate further feedback. Hence, the video data and audio data generated during the troubleshooting process may be used to establish a comprehensive troubleshooting knowledge resource hub for manufacturing users, clients, and companies.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for troubleshooting comprising:
(a) uploading a plurality of videos of troubleshooting collaborations between at least one service representative and at least one local site having equipment to be repaired, wherein the videos are taken at the at least one local site;
(b) developing a searchable database of the videos of troubleshooting collaborations, wherein developing the searchable database includes tagging the videos for data analytics; and
(c) responding to a search request for troubleshooting an operation of a particular piece of equipment, wherein the response includes video data from the searchable database.

2. The method of claim 1, further comprising sending video data from the searchable database through a communications network in response to the search request.

3. The method of claim 1, further comprising tracking the number of times the video data has been accessed in response to a request.

4. The method of claim 1, wherein the troubleshooting collaborations are related to installing, maintaining, or repairing a machine, piece of equipment, instrument, or appliance.

5. A non-transitory computer readable medium having executable instructions that, when executed by a processor, cause an apparatus to:
(a) upload a plurality of videos of troubleshooting collaborations between at least one service representative and at least one local site having equipment to be repaired, wherein the videos are taken at the at least one local site;
(b) develop a searchable database of the videos of troubleshooting collaborations, wherein the development of the searchable database includes tagging the videos for data analytics; and
(c) respond to a search request for troubleshooting an operation of a particular piece of equipment, wherein the response includes video data from the searchable database.

6. The non-transitory computer readable medium of claim 5, wherein the executable instructions are further operable to cause the apparatus to send video data from the searchable database through a communications network in response to the search request.

7. The non-transitory computer readable medium of claim 5, wherein the executable instructions are further operable to cause the apparatus to track the number of times the video data has been accessed in response to a request.

8. The non-transitory computer readable medium of claim 5, wherein the troubleshooting collaborations are related to repairing a machine, piece of equipment, instrument, or appliance.

9. A method for troubleshooting comprising:
(a) receiving a signal associated with a problem of a piece of equipment, instrument or machinery;
(b) in response to receiving the signal, initiating a communication channel capable of transmitting troubleshooting information between a user at a local site of the piece of equipment, instrument, or machinery, and at least one service representative at a remote site;
(c) transmitting information between the service representative and the user relating to the equipment, instrument, or machinery for purposes of troubleshooting the problem; and
(d) uploading a video of troubleshooting for the user relating to the equipment, instrument, or machinery taken at the local site.

10. The method of claim 9, wherein the communication channel is capable of transmitting at least one of audio data and video data, wherein the audio data or video data is transmitted in real-time.

11. The method of claim 9, wherein the transmitted information includes at least audio data and video data.

12. The method of claim 9, wherein the information transmitted by the service representative comprises at least a portion of video data from the local site and at least a portion of video data from the service representative.

13. The method of claim 12, wherein the portion of video data from the service representative overlays the portion of video data from the local site.

14. The method of claim 9, wherein the communication channel comprises the Internet.

15. The method of claim 9, further comprising uploading a recording of the communicated information between the user and the service representative to a database.

16. A non-transitory computer readable medium having executable instructions that, when executed by a processor, cause an apparatus to:
(a) receive a signal associated with a problem with a piece of equipment, instrument or machinery;
(b) in response to receiving the signal, initiate a communication channel capable of transmitting information between a user at a local site and at least one service representative;
(c) transmit information between the user and the service representative relating to the equipment, instrument, or machinery for purposes of troubleshooting the problem; and
(d) uploading a video of troubleshooting for the user relating to the equipment, instrument, or machinery taken at the local site.

17. The non-transitory computer readable medium of claim 16, wherein the information transmitted by the service representative comprises at least a portion of video data from the local site and at least a portion of video data from the service representative, wherein the communication channel can transmit data in real-time.

18. The non-transitory computer readable medium of claim 16, wherein the portion of video data from the service representative overlays the portion of video data from the local site.

19. The non-transitory computer-readable medium of claim 18, wherein the portion of the video data being overlaid comprises at least one of a two-dimensional or three-dimensional computer aided drawing, and a graphical representation, created by the user or the service representative, of a portion of a troubleshooting procedure.

20. The non-transitory computer readable medium of claim 16, wherein the executable instructions are further operable to cause the apparatus to upload a recording of the communicated information between the user and the service representative to a database.
